(19) United States
(12) Patent Application Publication
(10) Pub. No.: US 2013/0036006 A1
(43) Pub. Date: Feb. 7, 2013

(54) ADVERTISEMENT MATCHING

(71) Applicants: Mohamed M. HEFEEDA, Doha (QA); Hamed A. Neshat, Burnaby (CA)

(72) Inventors: Mohamed M. HEFEEDA, Doha (QA); Hamed A. Neshat, Burnaby (CA)

(73) Assignee: Qatar Foundation, Doha (QA)

(21) Appl. No.: 13/198,419

(22) Filed: Aug. 4, 2011

(51) Int. Cl. G06Q 30/02

(52) U.S. Cl. 705/14.49

(57) ABSTRACT

A computer-implemented method comprises of processing data for a source video to determine representative topics of the video, determining multiple topics of interest for respective ones of multiple market segments, using the representative topics and the multiple topics to determine a target audience for the video from the market segments, using the topics of interest for the target audience to determine a set of keywords for an advertisement, using the set of keywords to provide multiple candidate advertisements for the target audience, generating a ranked list from the multiple candidate advertisements, and selecting an advertisement for the source video from the ranked list of candidate advertisements.

The present invention relates to advertisement matching, and, in particular, to advertisement matching for online video.

### BACKGROUND

Online video is a growing medium. The popularity of online video services reflects this growth. Advertisers see online video as another way to reach their customers. Many advertisers are interested in maximizing the number of actions (e.g., impressions and/or click-throughs) for their advertisements (or “ads”). To achieve this, advertisers make efforts to target advertisements to content that is considered relevant.

Ads in online videos can take different forms, including: (i) a short video clip displayed before or during a retrieved video, (ii) a text message overlaid on the video, and (iii) an image or video overlaid on the video or displayed near to it. Typically, Internet video sites attach ads to videos based on matching the ads' keywords with the metadata describing the contents of the videos. For example, if videos are classified into categories, the advertiser can target advertisements to the videos based on those categories.

Some sites can also automatically create descriptions for videos by analyzing their visual contents and/or their audio signals after converting them to text. Typically, ads and videos that have similar contents are associated with each other. For example, if a video contains information about cars, ads related to cars can be attached to this video.

Accordingly, ads for display on or near a video are typically selected on the basis of the content of that video.

### SUMMARY

According to an example, there is provided a computer-implemented method comprising processing data for a source video to determine representative topics of the video, determining multiple topics of interest for respective ones of multiple market segments, using the representative topics and the multiple topics to determine a target audience for the video from the market segments, using the topics of interest for the target audience to determine a set of keywords for an advertisement, using the set of keywords to provide multiple candidate advertisements for the target audience, generating a ranked list from the multiple candidate advertisements, and selecting an advertisement for the source video from the ranked list of candidate advertisements. In an example, selecting an advertisement includes using a measure of interest of the target audience. The method can further comprise inserting an advertisement from the ranked list into the source video, and an inserted advertisement can be an advertisement which is relatively highly ranked in the ranked list.

In an example, a method can further comprise using an advertisement from the ranked list in a location near the source video. The multiple candidate advertisements can be selected from a database of advertisements. The method can further comprise determining a profile for respective ones of the market multiple segments.

According to an example, there is provided apparatus for matching an advertisement to a source video, comprising a processor to process data for the source video to determine representative topics of the video, determine multiple topics of interest for respective ones of multiple market segments, process data representing the representative topics and the multiple topics to determine a target audience for the video from the market segments, process data representing the topics of interest for the target audience to determine a set of keywords for an advertisement, process data representing the set of keywords to provide multiple candidate advertisements for the target audience, generate a ranked list from the multiple candidate advertisements, and select an advertisement for the source video from the ranked list of candidate advertisements.

According to an example, there is provided a computer program embedded on a non-transitory tangible computer readable storage medium, the computer program including machine readable instructions that, when executed by a processor, implement a method for matching an advertisement to a source video comprising processing data for a source video to determine representative topics of the video, determining multiple topics of interest for respective ones of multiple market segments, using the representative topics and the multiple topics to determine a target audience for the video from the market segments, using the topics of interest for the target audience to determine a set of keywords for an advertisement, using the set of keywords to provide multiple candidate advertisements for the target audience, generating a ranked list from the multiple candidate advertisements, and selecting an advertisement for the source video from the ranked list of candidate advertisements. In an example, selecting an advertisement can include using a measure of interest of the target audience. The method can further comprise inserting an advertisement from the ranked list into the source video. An inserted advertisement can be an advertisement which is relatively highly ranked in the ranked list.

In an example, the method can further comprise using an advertisement from the ranked list in a location near the source video. The multiple candidate advertisements can be selected from a database of advertisements. The method can further comprise determining a profile for respective ones of the market multiple segments.

### BRIEF DESCRIPTION OF THE DRAWINGS

An embodiment of the invention will now be described, by way of example only, and with reference to the accompanying drawings, in which:

FIG. 1 is a block diagram of a method according to an example;

FIG. 2 is a schematic block diagram of method for determining the topic of a video according to an example;

FIG. 3 is a schematic block diagram of a method according to an example; and

FIG. 4 is a schematic block diagram of an apparatus according to an example.

### DETAILED DESCRIPTION

The current approach for matching ads with videos assumes that if a user is watching a video about a specific subject, s/he will be interested in buying goods and services related to that subject. This assumption is not always true, because the purchasing or shopping interests of a user do not necessarily match the contents of videos s/he watches online. According to an example, there is provided a method and system for matching ads with online videos based on shopping and/or purchasing interests of a target audience of videos in order to maximize the number of users who purchase goods and services offered by advertisers.

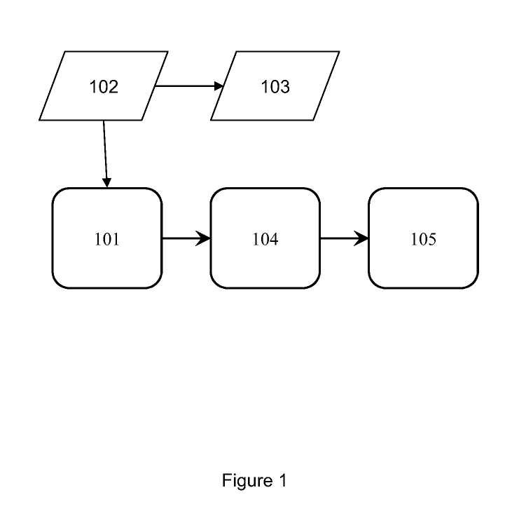

FIG. 1 is a block diagram of a method according to an example. For a source video 101, which is a video that has been selected, or is being watched by a user, video topics are detected in block 104. For example, video data 102 can include metadata 103 which details certain keywords for the video 101 such as keywords which represent certain topics, categories or taxonomies for the video 101. Alternatively, data which is separate from the video data 102 (such as stored in a different file for example) can be used to store category or topic information for a video. Further alternatively, a video can have a corresponding database (or similar) entry which details certain information for the video including topics, categories, keywords etc. for the video.

In an example, videos and associated ads can be associated with one or more keywords. Ads' keywords are typically specified by advertisers, but online video sites which distribute the ads can provide some guidance and suggestions for keywords.

In block 105, information relating to a target audience is determined. For example, some videos hosted by online video websites also store and provide statistics about the audience for those videos which can be used to determine a profile for a video in relation to a target audience. According to an example, a target audience can therefore be determined. In the case where audience statistics are not available, a method is described below for determining such information.

In an example, viewers are classified into multiple groups based on marketing and advertising studies. Classification of viewers can depend on several metrics according to an example, including age, location, and gender. Accordingly, categorisation can be based on audience age and gender such as depicted in the table below.

| | | Percent of | |
|---|---|---|---|
| | Unique Visitors | Visitors | Reach of Online |
| Demo | (MM) | (%) | Universe (%) |
| 2-11 | 6.8 | 7% | 39% |
| 12-17 | 8.6 | 9% | 61% |
| 18-24 | 11.3 | 11% | 62% |
| 25-34 | 17.7 | 18% | 57% |
| 35-49 | 27.6 | 28% | 53% |
| 50-64 | 18.2 | 18% | 43% |
| 65+ | 8.8 | 9% | 45% |
| Male | 47.9 | 48% | 52% |
| Female | 51.1 | 52% | 50% |

Typically, within each viewer group or category there is a list of shopping interests. For example, the table below shows a top ten listing of shopping interests for teenagers between 13 and 17 years old in the USA.

| Interest | Males % | Females % | Overall % |
|---|---|---|---|
| 1—Clothes | 21 | 43 | 64 |
| 2—Food | 30 | 31 | 61 |
| 3—Candy | 24 | 34 | 58 |
| 3—Soda or Soft Drinks | 26 | 32 | 58 |
| 4—Salty Snacks | 15 | 22 | 37 |
| 4—CDs or Recorded Music | 19 | 18 | 37 |
| 5—Lunch | 13 | 22 | 35 |
| 6—Shoes | 15 | 16 | 31 |
| 7—Video Games | 18 | 5 | 23 |
| 8—Jewelry | 7 | 15 | 22 |
| 9—Magazines | 9 | 12 | 21 |
| 10—Ice Cream | 7 | 10 | 17 |

A method and system according to an example maps the interests of viewer groups to a common hierarchical keyword structure. Thereby, multiple ranked ads for a video can be selected such that the ads are relevant to viewers of that video. In an example, relevance means that goods and services advertised by ads are of interest to the target viewers of videos.

According to an example, a method and system therefore analyses a video in order to identify potential viewer groups. To that end, the system looks at associated keywords or existing statistics about viewers. Once the potential viewer groups for a given video are identified, their shopping interests become known using available information such as that in the tables provided above, which are a subset of the information available and provided only for the purposes of illustration.

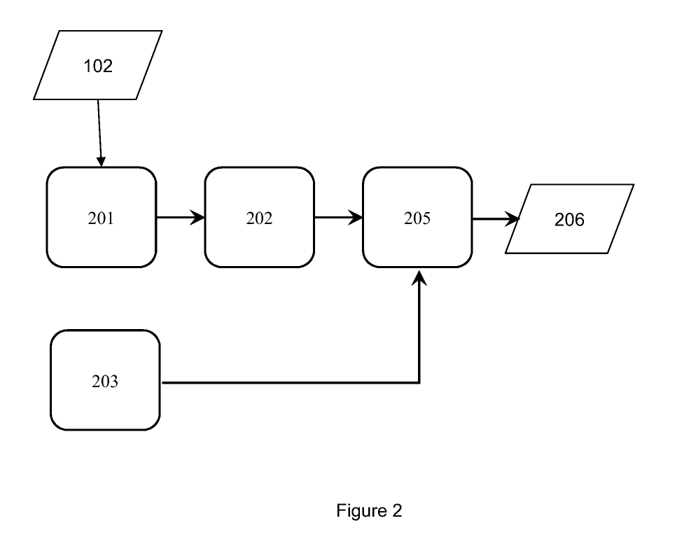

FIG. 2 is a schematic block diagram of method for determining the topic of a video according to an example. As described above, in order to determine which categories a video belongs to, the video's associated keywords are used. In block 201 a vector 202 with entries corresponding to topics to which the video pertains is formed. Given video data 102, keywords relating to each topic for the video are determined and the corresponding entry in the vector is populated accordingly. Since some topics are sub-topics, and in order to give more weight to narrower topics which categorise the video with a finer level of granularity, for those keywords which could be matched with lower topics the corresponding entry for both lower topics in a hierarchy and their parent is increased. Accordingly, for a video V, there is a vector 202 of the form:

V:(<t₁,k₁>,<t₂,k₂>,<t₃,k₃>, . . . ,<tₙ,kₙ>)

where tᵢ is the name of the topic (product category for example), and kᵢ is the number of keywords for topic tᵢ that the video includes. In an example, a keyword tool can be used to find a keyword's topic. Typically, such tools allow a user to determine a set of keywords based on a description or another representative keyword of a product or service.

For example, consider “motor cycle” as an associated video keyword. Typically, suggested high level related topics could include “Computers”, “Sports & Fitness”, and “Vehicles”; and “Computer Accessories” (from Computers), “Sporting Goods” (from Sports & Fitness), “Motor Vehicles and Vehicles Parts & Accessories” (from Vehicles) as lower level or narrower topics. The resultant vector, V, would therefore be:

V=(<computerAccessories,1>,<Computers,1>,<SportingGoods,1>,<Sports&Fitness,1>,<MotorVehicles,1>,<VehiclesParts&Accessories,1>,<Vehicles,2>)

Note that null entries are not shown. In an example, null entries are present in the vector and can be used for computing a similarity score. They have no impact on a score, but it can be desirable to have consistent vectors for all videos.

According to an example, interests for a target audience group A can be represented as a vector 203 of the form:

(<t₁,w₁>,<t₂,w₂>,<t₃,w₃>, . . . ,<tₙ,wₙ>)

where tᵢ is the name of a product's category, and wᵢ is a weight representative of a measure of how much the target audience are interested in this specific topic.

In order to know to what degree a video is related to each target audience, according to an example, a Cosine Similarity measure for target audience interests vector (A) and video keyword's topics vector (V) is computed in block 205, where:

$$Similarity = \frac{V \cdot A}{‖ V ‖ ‖ A ‖} = \frac{{\sum }_{i = 1}^{n} {k}_{i} \times {w}_{i}}{\sqrt{{\sum }_{i = 1}^{n} {( {k}_{i} )}^{2}} \times \sqrt{{\sum }_{i = 1}^{n} {( {w}_{i} )}^{2}}}$$

where V is the video keywords/topic vector and A is target audience-interests vector. The value of k represents how many keywords a video has from topic tᵢ, and wᵢ is a weight showing by what degree a topic tᵢ is considered interesting to a target audience.

According to an example, the similarity can be computed for multiple target audience groups, such as the groups described above in the age/gender table. For all topics that are further categorised under another topic, the same weight as their parent topic can be assigned. However, since those keywords which matched with narrower topics will be counted twice (one for the matched topic, another one for parent topic), the above computation automatically gives a more weighted measure to narrower topics.

After computing the cosine similarity for each target audience, the results, 206, can be ranked. According to an example, the higher a similarity score is, the more relevant a target audience will be to the video in question. Accordingly, ranking can proceed by listing similarity scores in descending order in order to provide a ranked list of relevant audiences for a video.

Accordingly, given a video and its target audience, candidate ads for the video's target audience are determined. The candidate ads are those ones which have at least one keyword under an interesting topic for the video's target audience. Typically, since the number of ads which are determined is usually greater than the number of available ad spots, the candidate ads are ranked so that only the most relevant are inserted or selected.

According to an example, ads can be ranked by looking at their associated keywords and following a procedure which is similar to that described above with reference to finding a target audience for a video. However, instead of using a different target audience, a cosine similarity between determined target audience interests and candidate ads is computed. A higher score represents an ad which has potentially more interest for a video target audience. For a vector:

D:(<t₁,kᵢ>,<t₂,k₂>,<t₃,k₃>, . . . ,<tₙ,kₙ>)

where tᵢ is the name of a topic (such as a product category for example), and kᵢ represents the number of keywords an ad has from topic tᵢ, then the similarity score can be computed according to:

$$Similarity = \frac{D \cdot A}{‖ D ‖ ‖ A ‖} = \frac{{\sum }_{i = 1}^{n} {k}_{i} \times {w}_{i}}{\sqrt{{\sum }_{i = 1}^{n} {( {k}_{i} )}^{2}} \times \sqrt{{\sum }_{i = 1}^{n} {( {w}_{i} )}^{2}}}$$

where D is an ad keyword-topic vector and A is a target audience interests vector. The value k is a measure for the number of keywords an ad has from topic t, and w is a weight which indicates how much topic t is considered to be interesting to the target audience. Once the similarity is calculated, the measures for ads can be ranked in order to provide a listing of the most relevant ads for insertion in or around a video. According to an example, a measure of interestingness can be determined heuristically. According to an example, a weight can be determined heuristically and accorded a value such as those given below, which represents a set of interesting topics for teenagers between 13 and 17 years old.

| Interest | Weight | | |
|---|---|---|---|
| Topic | Males | Females | Overall |
| 1—Food | 115 | 151 | 266 |
| 2—Apparel | 43 | 74 | 117 |
| 3—Media & Events | 28 | 30 | 58 |
| 4—Hobbies & Leisure | 18 | 5 | 23 |

Accordingly, audience-interest vectors (A) for male and female teenagers (target audience between 13-17 years old) can be represented as:

### (Food, 115, Apparel, 43, Media&Events, 28, Hobbies&Leisure, 18), and (Food, 151, Apparel, 4, Media&Events, 30, Hobbies&Leisure, 5)

Note that other topics which are not included in the audience-interest vectors have zero weight.

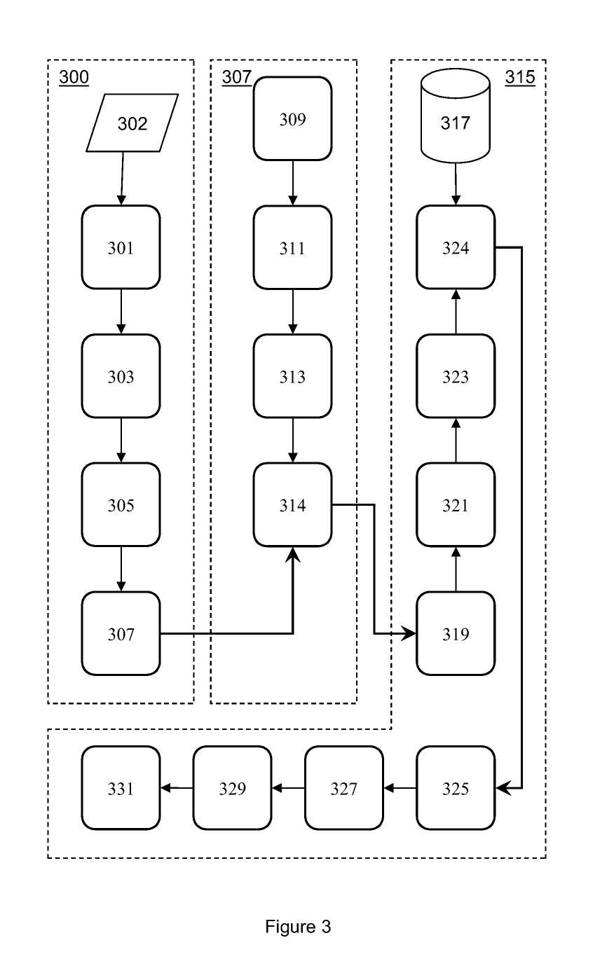

FIG. 3 is a schematic block diagram of a method according to an example. In block 300, topics of a video 301 are determined using video data 302. The video 301 can be a selected video, such as a video selected for viewing by a user for example. Video keywords 303 are extracted or otherwise determined as described above, and the keywords are used to determine topics 305 for video 301.

In block 307, target audience interests are determined. For a set of market group segments 309, segment profiles 311 are constructed. For example, profiles can be based on age, gender etc. as described above and use heuristic data to determine a set of interesting topics 313 for each segment profile. For example, marketing studies can be used to find interests.

For example, the top ten shopping interests for teenagers between 13 and 17 years old in the USA can provide useful data representing this market segment. In an example, the determined interests are then mapped to a common hierarchical keyword structure. Typically, the structure can be a predetermined structure which can be part of a keyword determination tool for example. A target audience for the video 301 is then determined in block 314 using the topics determined in block 313, and the video topics 307.

In block 315, candidate ads for insertion in or around the video 301 are determined. A database 317 stores ads. For example, a video hosting site may have a database (or have access to a database) such as 317 in which ads are stored for retrieval so that they can be used, such as being inserted in or around a video of the hosting site.

In block 319, the topics which are considered interesting to a determined target audience are computed as described above. The keywords for the topics are extracted in block 321 to provide keywords 323 which are then matched in block 324 with ads from the database 317 to provide a set of matching ads 325. According to an example, matching ads 325 are ranked in block 327 according to a measure of interestingness as described above in order to provide a ranked list of selected ads 329.

In block 331, the or each ad which is highly ranked in the list 329 can be inserted in or around the video 301.

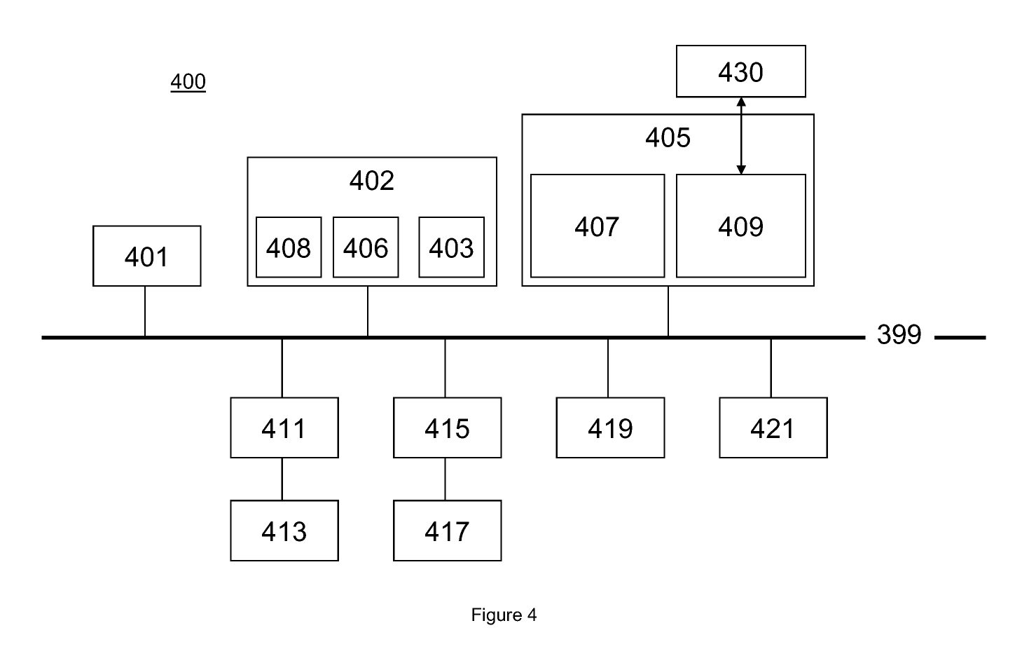

FIG. 4 is a schematic block diagram of an apparatus suitable for matching advertisements according to an example. Apparatus 400 includes one or more processors, such as processor 401, providing an execution platform for executing machine readable instructions such as software. Commands and data from the processor 401 are communicated over a communication bus 399. The system 400 also includes a main memory 402, such as a Random Access Memory (RAM), where machine readable instructions may reside during runtime, and a secondary memory 405. The secondary memory 405 includes, for example, a hard disk drive 407 and/or a removable storage drive 430, representing a floppy diskette drive, a magnetic tape drive, a compact disk drive, etc., or a non-volatile memory where a copy of machine readable instructions or software may be stored. The secondary memory 405 may also include ROM (read only memory), EPROM (erasable, programmable ROM), EEPROM (electrically erasable, programmable ROM). In addition to software, data representing any one or more of video data, source data, metadata; advertisement data, vector data and/or data representing video topics for example may be stored in the main memory 402 and/or the secondary memory 405. The removable storage drive 430 reads from and/or writes to a removable storage unit 409 in a well-known manner.

A user interfaces with the system 400 with one or more input devices 411, such as a keyboard, a mouse, a stylus, and the like in order to provide user input data. The display adaptor 415 interfaces with the communication bus 399 and the display 417, and receives display data from the processor 401 and converts the display data into display commands for the display 417. A network interface 419 is provided for communicating with other systems and devices via a network (not shown). The system can include a wireless interface 421 for communicating with wireless devices in the wireless community.

It will be apparent to one of ordinary skill in the art that one or more of the components of the system 400 may not be included and/or other components may be added as is known in the art. The system 400 shown in FIG. 4 is provided as an example of a possible platform that may be used, and other types of platforms may be used as is known in the art. One or more of the steps described above may be implemented as instructions embedded on a computer readable medium and executed on the system 400. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

According to an example, data 403 representing a target audience or video vector can reside in memory 402. A similarity computation engine 406 can be used to compute cosine similarity measures according to the above. A weighting Module 408 can be used to derive and/or allocate weight values according to an example. A database 317 can reside on a HDD such as 405, or can be provided on a removable storage unit 409 for example.

What is claimed is:

1. A computer-implemented method comprising:
processing data for a source video to determine representative topics of the video;
determining multiple topics of interest for respective ones of multiple market segments;
using the representative topics and the multiple topics to determine a target audience for the video from the market segments;
using the topics of interest for the target audience to determine a set of keywords for an advertisement;
using the set of keywords to provide multiple candidate advertisements for the target audience;
generating a ranked list from the multiple candidate advertisements; and
selecting an advertisement for the source video from the ranked list of candidate advertisements.

2. A computer-implemented method as claimed in claim 1, wherein selecting an advertisement includes using a measure of interest of the target audience.

3. A computer-implemented method as claimed in claim 1, further comprising inserting an advertisement from the ranked list into the source video.

4. A computer-implemented method as claimed in claim 1, further comprising inserting an advertisement from the ranked list into the source video, wherein an inserted advertisement is an advertisement which is relatively highly ranked in the ranked list.

5. A computer-implemented method as claimed in claim 1, further comprising using an advertisement from the ranked list in a location near the source video.

6. A computer-implemented method as claimed in claim 1, wherein the multiple candidate advertisements are selected from a database of advertisements.

7. A computer-implemented method as claimed in claim 1, further comprising determining a profile for respective ones of the market multiple segments.

8. Apparatus for matching an advertisement to a source video, comprising a processor operable to:
process data for the source video to determine representative topics of the video;
determine multiple topics of interest for respective ones of multiple market segments;
process data representing the representative topics and the multiple topics to determine a target audience for the video from the market segments;
process data representing the topics of interest for the target audience to determine a set of keywords for an advertisement;
process data representing the set of keywords to provide multiple candidate advertisements for the target audience;
generate a ranked list from the multiple candidate advertisements; and
select an advertisement for the source video from the ranked list of candidate advertisements.

9. A computer program embedded on a non-transitory tangible computer readable storage medium, the computer program including machine readable instructions that, when executed by a processor, implement a computer-implemented method for matching an advertisement to a source video comprising:
processing data for a source video to determine representative topics of the video;
determining multiple topics of interest for respective ones of multiple market segments;
using the representative topics and the multiple topics to determine a target audience for the video from the market segments;
using the topics of interest for the target audience to determine a set of keywords for an advertisement;
using the set of keywords to provide multiple candidate advertisements for the target audience;
generating a ranked list from the multiple candidate advertisements; and
selecting an advertisement for the source video from the ranked list of candidate advertisements.

10. A computer program as claimed in claim 9, wherein selecting an advertisement includes using a measure of interest of the target audience.

11. A computer program as claimed in claim 9, further comprising inserting an advertisement from the ranked list into the source video.

12. A computer program as claimed in claim 9, further comprising inserting an advertisement from the ranked list into the source video, wherein an inserted advertisement is an advertisement which is relatively highly ranked in the ranked list.

13. A computer program as claimed in claim 9, further comprising using an advertisement from the ranked list in a location near the source video.

14. A computer program as claimed in claim 9, wherein the multiple candidate advertisements are selected from a database of advertisements.

15. A computer program as claimed in claim 9, further comprising determining a profile for respective ones of the market multiple segments.
